(19) United States
(12) Patent Application Publication
(10) Pub. No.: US 2024/0221364 A1
(43) Pub. Date: Jul. 4, 2024

(54) GENERATING TRAINING DATA USING REAL-WORLD SCENE DATA AUGMENTED WITH SIMULATED SCENE DATA

(71) Applicant: GM Cruise Holdings LLC, San Francisco, CA (US)

(72) Inventors: Yiru Shen, Lynnwood, WA (US); Minhao Xu, San Jose, CA (US); Xianming Liu, San Carlos, CA (US); Ignacio Martin Bragado, Mountain View, CA (US)

(21) Appl. No.: 18/092,868

(22) Filed: Jan. 3, 2023

(51) Int. Cl. G06V 10/774; G06T 11/00; G06V 20/56

(52) U.S. Cl. CPC G06V 10/774; G06T 11/00; G06V 20/56

(57) ABSTRACT

Systems and techniques are provided for generating training data using real-world scene data augmented with simulated scene data. A simulation platform can be configured to augment real-world AV scene data with synthetic AV scene data that describes objects that have been added to a simulated real-world scenario. For example, the simulation platform can use real-world AV scene data to simulate a real-world scenario and then add an object to the simulation of the real-world scenario. The simulation platform augments the real-world AV scene data to add in the simulated object. The resulting augmented real-world AV scene data includes the added object, while also maintaining the accuracy of the surrounding environment that is provided by the real-world AV scene data.

### BACKGROUND

### 1. Technical Field

The present disclosure generally relates to autonomous vehicles and, more specifically, to generating training data using real-world scene data augmented with simulated scene data.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. For example, the internal computing system may utilize machine learning models to interpret the data and measurements and decide on what actions should be performed to maintain a safe and comfortable riding experience.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example autonomous vehicle (AV) management system, according to some examples of the present disclosure.

FIG. 2 is a block diagram of a simulation platform configured to generate augmented real-world AV scene data based on synthetic AV scene data, according to some examples of the present disclosure.

FIGS. 3A-3B illustrate augmenting real-world AV scene data based on synthetic AV scene data, according to some examples of the present disclosure.

FIG. 4 is a flowchart diagram illustrating an example process for generating augmented real-world AV scene data based on synthetic AV scene data, according to some examples of the present disclosure.

FIG. 5 is a flowchart diagram illustrating an example process for augmenting real-world AV scene data based on distance values associated with corresponding real-world and synthetic data points, according to some examples of the present disclosure.

FIG. 6 illustrates an example of a deep learning neural network that can be used in accordance with some examples of the present disclosure.

FIG. 7 is a diagram illustrating an example system architecture for implementing certain aspects described herein.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the current environment of the AVs (e.g., AV scenes) and move without human input. For example, AVs can include sensors such as a camera sensor, a LIDAR sensor, and/or a RADAR sensor, amongst others, which the AVs can use to collect AV scene data (e.g., sensor data and measurements) that is used for various AV operations. The sensors can provide the AV scene data to an internal computing system of the AV, which can then use the AV scene data to control mechanical systems of the AV, such as a vehicle propulsion system, a braking system, and/or a steering system, etc. For example, the internal computing system may use the AV scene data as input into machine learning models that interpret the AV scene data and provide outputs which are used to decide what actions should be performed to maintain a safe and comfortable riding experience.

The machine learning models (e.g., machine learning algorithms) used by AVs are generated (e.g., trained) using AV scene data gathered during operation of multiple AVs. The AV scene data describes the real-world environment of the AVs as they operate in various real-world scenarios. A scenario may be a specified time period during which AV scene data is collected. The AV scene data may include data describing the AV during the real-world scenario, such as the location, speed, and/or trajectory of the AV, as well as include data identifying the objects in the surrounding environment of the AV during the real-world scenario, such as the object type, size, shape, location, speed and/or trajectory of the objects. The performance of the machine learning models in a particular scenario is related to the amount of AV scene data describing the same or a similar scenario that was used to train the machine learning model. For example, the performance of a machine learning model used to identify objects (e.g., pedestrians, vehicles, etc.) in the surrounding environment is improved as the machine learning model is trained with additional AV scene data that includes the objects.

One challenge with training machine learning models for use with AVs is capturing adequate amounts of AV scene data to properly train the machine learning models to operate in various scenarios. For example, certain scenarios, such as a pedestrian unexpectedly running across the street, the presence of unique vehicles, or a vehicle running a red light may occur infrequently during daily driving. As a result, capturing a sufficient or desired amount of real-world AV scene data describing these scenarios to train machine learning models may take a long time.

A simulation platform can be used to generate synthetic AV scene data to increase the speed at which training data is captured and available for training machine learning models for use in AVs. For example, a simulation platform can generate computer-generated simulations of real-world scenarios from which synthetic AV scene data describing the simulated real-world scenario can be generated. The resulting synthetic AV scene data can then be used to train the machine learning models to operate in similar real-world scenarios.

While use of synthetic AV scene data substantially increases the speed at which the training data can be captured, the value in doing so is dependent on the accuracy of the simulated real-world scenarios generated by the simulation platform. For example, if the simulated scenario does not accurately represent a real-world scenario, the resulting synthetic AV scene data may not be suitable to train a machine learning model to operate in similar real-world environments. Accordingly, improving the quality of the synthetic AV scene data results in improved performance of the machine learning models that are trained using the synthetic AV scene data.

Currently, simulation platforms provide highly accurate representation of certain object in simulations such as vehicles, pedestrians, etc. For example, the synthetic AV scene data describing these objects rivals the quality and accuracy of real-world AV scene data captured during real-world scenarios. Simulation platforms, however, are not as accurate at representing the general surrounding environment, such as the buildings, roads, and trees. That is, the synthetic AV scene data describing the general surrounding environment is not as accurate as the real-world AV scene data captured during real-world scenes. As a result, the synthetic AV scene data generated using simulations may not be as accurate as real-world AV scene data.

To alleviate this issue, a simulation platform can be configured to augment real-world AV scene data with synthetic AV scene data that describes objects that have been added to a simulated real-world scenario. For example, the simulation platform can use real-world AV scene data to simulate a real-world scenario and then add an object to the simulation of the real-world scenario. The simulation platform augments the real-world AV scene data to add in the simulated object. The resulting augmented real-world AV scene data includes the added object, while also maintaining the accuracy of the surrounding environment that is provided by the real-world AV scene data.

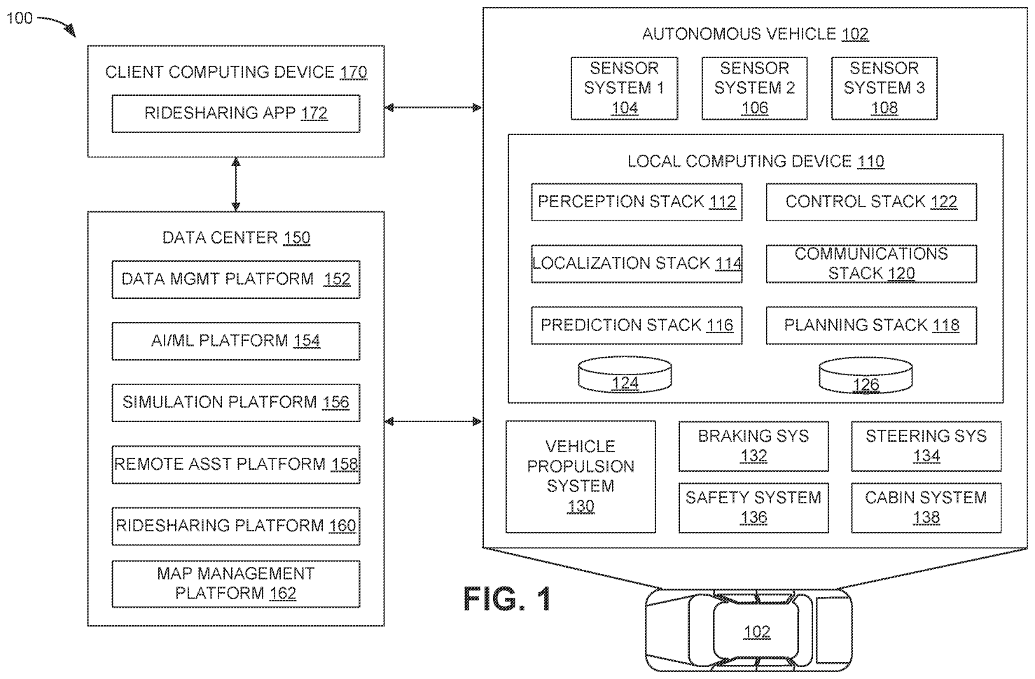

FIG. 1 is a diagram illustrating an example autonomous vehicle (AV) management system 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill in the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102: communicating with the data center 150, the client computing device 170, and other systems: receiving inputs from riders, passengers, and other entities within the AV's environment: logging metrics collected by the sensor systems 104-108: and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area (e.g., bounding box) around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating: turn on the left blinker, decelerate if the AV is above a threshold range for turning, and turn left: turn on the right blinker, accelerate if the AV is stopped or below the threshold range for turning, and turn right: decelerate until completely stopped and reverse: etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth® R, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes: legal or illegal u-turn lanes: permissive or protected only right turn lanes: etc.). The traffic controls lane can include geospatial information of traffic signal lights, traffic signs, and other road objects and related attributes.

The AV operational database 124 can store AV scene data, including raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (Saas) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108 (e.g., AV scene data), roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms (e.g., machine learning models) for operating the AV 102, the simulation platform 156, the remote assistance platform 158, the ridesharing platform 160, the map management platform 162, and other platforms and systems. Using the AI/ML platform 154, data scientists can prepare data sets from the data management platform 152: select, design, and train machine learning models: evaluate, refine, and deploy the models: maintain, monitor, and retrain the models: and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from AV scene data captured by the AV 102, including rendering geospatial information and road infrastructure (e.g., streets, lanes, crosswalks, traffic lights, stop signs, etc.) obtained from a cartography platform (e.g., map management platform 162): modeling the behavior of other vehicles, bicycles, pedestrians, and other dynamic elements: simulating inclement weather conditions, different traffic scenarios: and so on.

The simulation platform 156 can be used to generate synthetic AV scene data to increase the speed at which training data is captured and available for training machine learning models. For example, the simulation platform 156 can generate simulations of real-world scenarios from which synthetic AV scene data can be captured. The resulting synthetic AV scene data can then be used to train the machine learning models to operate in similar real-world scenarios.

As discussed earlier, the simulation platform 156 provides highly accurate representations of certain object in simulations such as vehicles, pedestrians, etc., however, the simulation platform 156 provides less accuracy when representing the general surrounding environment, such as the buildings, roads, and trees. Accordingly, the synthetic AV scene data may not describe the general surrounding environment as accurately as real-world AV scene data.

To allow for simulation of new real-world scenarios while maintaining the highly accurate representation of the surrounding environment provided by real-world AV scene data, the simulation platform 156 augments real-world AV scene data with synthetic AV scene data that describes objects that have been added to a simulated real-world scenario. For example, the simulation platform 156 uses real-world AV scene data to generate a simulation of the real-world scenario described by the real-world AV scene data. The simulation platform may then add one or more objects to the simulation of the real-world scenario to create new real-world scenarios. For example, the simulation platform 156 may add objects to the generated simulation, such as vehicles or pedestrians, that the simulation platform 156 can represent with high levels of accuracy. The simulation platform 156 then augments the real-world AV scene data used to generate the simulation based on the synthetic AV scene data captured from the simulation to add in the new objects. The resulting augmented real-world AV scene data includes the added object, which is represented with a high level of accuracy by the synthetic AV scene data, while also maintaining the highly accurate real-world AV scene data that describes the surrounding environment.

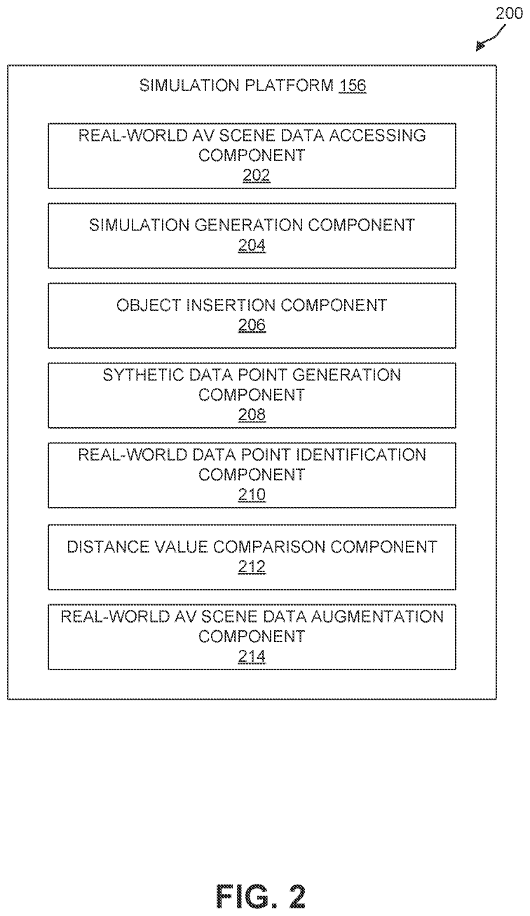

The functionality of the simulation platform 156 related to generating augmented real-world AV scene data based on synthetic AV scene data is described in greater detail below in relation to FIGS. 2-5.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160) can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., files (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some aspects, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

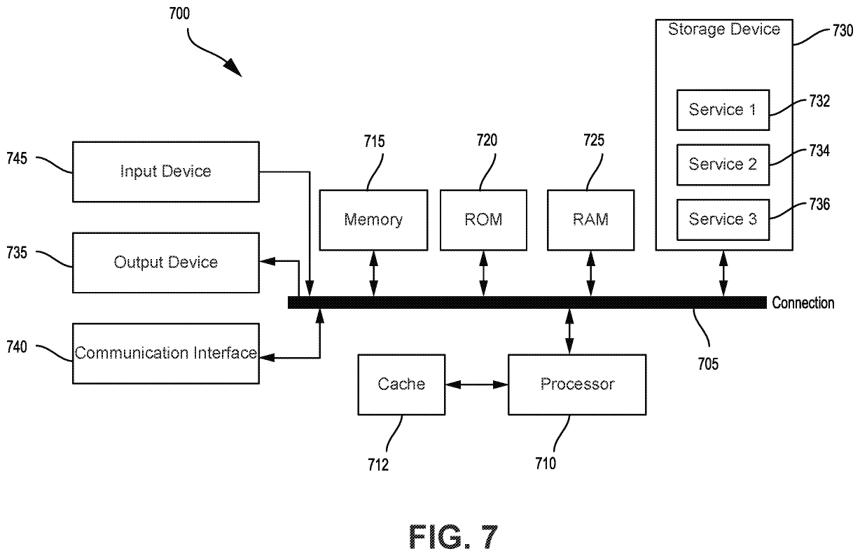

While the autonomous vehicle 102, the local computing device 110, and the AV management system 100 are shown to include certain systems and components, one of ordinary skill will appreciate that the autonomous vehicle 102, the local computing device 110, and/or the AV management system 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

As noted above, the time it takes for an AV to process sensor input data may vary based on many different factors. For instance, the complexity of the environment surrounding the AV (e.g., scene complexity) can cause variations in compute time because of the amount of sensor data that is collected, and the processing time required to identify objects in the scene, predict behavior of the objects, etc. In some cases, an AV may initiate a safe stop if the AV determines that the latency in processing input data exceeds a safety threshold and/or a passenger comfort threshold.

FIG. 2 is a block diagram 200 of a simulation platform 156 configured to generate augmented real-world AV scene data based on synthetic AV scene data, according to some examples of the present disclosure. As discussed earlier, the simulation platform 156 can be used to generate synthetic AV scene data to increase the speed at which training data is captured and available for training machine learning models. While the simulation platform 156 provides highly accurate representations of certain objects in simulations such as vehicles, pedestrians, etc., the simulation platform 156 provides less accuracy than real-world AV scene data when representing the general surrounding environment, such as the buildings, roads, and trees. To allow for simulation of new real-world scenarios while maintaining the highly accurate representation of the surrounding environment provided by real-world AV scene data, the simulation platform 156 augments real-world AV scene data with synthetic AV scene data that describes objects that have been added to a simulated real-world scenario. The resulting augmented real-world AV scene data includes at least one added object, which is represented with a high level of accuracy by the synthetic AV scene data, while also maintaining the highly accurate real-world AV scene data that describes the surrounding environment.

As shown, the simulation platform 156 includes a real-world AV scene data accessing component 202, a simulation generation component 204, an object insertion component 206, a synthetic data point generation component 208, a real-world data point identification component 210, a distance value comparison component 212, and a real-world AV scene data augmentation component 214.

The real-world AV scene data accessing component 202 accesses real-world AV scene data that describes a real-world AV scenario. The real-world AV scene data may include sensor data captured by sensors and/or generated by the various stacks of an AV that describe the surrounding environment of the AV during the real-world AV scenario, such as the location, size, trajectory, and speed of the AV and/or objects surrounding the AV in the real-world environment. For example, the real-world AV scene data may include real-world data points that describe the location of objects in the real-world environments in relation to the AV. The real-world data points may be associated with vector data describing the direction of the real-world data points from the AV (e.g., direction, angle, etc.) as well as distance values (e.g., depth values) that indicate the distance of the real-world data point from the AV. For example, the real-world data points may be generated using LIDAR sensors that cast rays from the AV and detect the depth of objects in the surrounding environment relative to the AV. In some embodiments, the real-world data points may also include image data, such as pixels captured using an optical sensor (e.g., camera), as well as vector data and distance values captured using different sensors, such as a LIDAR sensor.

The real-world AV scene data may also include labels and bounding boxes for the objects in the real-world environment. The labels identify the type of object, such as the whether the object is a vehicle, building, pedestrian and the like. The labels may be determined using machine learning models and/or be assigned by human reviewers. The bounding box for an object defines a geographic boundary of the object within the real-world scenario. For example, the bounding box indicates a size and shape of the object.

The real-world AV scene data accessing component 202 may provide the real-world AV scene data to the other components of the simulation platform 156, such as the simulation generation component 204.

The simulation generation component 204 generates simulations of real-world scenarios. For example, the simulation generation component 204 uses the real-world AV scene data to generate a simulation of the real-world scenario. This includes placement of the objects detected in the real-world scenario within the simulation to match the positions of the objects relative to the AV in the real-world scenario, as well as configuring the behavior of the AV and the objects within the simulation in a manner that matches their behavior in the real-world scenario. For example, the simulation generation component 204 may configure the speed, trajectory and/or pose of the AV and the surrounding objects within the simulation to match the speed, trajectory and/or pose of the AV and the surrounding objects that occurred in the real-world scenario.

The object insertion component 206 inserts objects into a simulation of a real-world scenario to simulate new real-world scenarios. An object may be any type of object, such as a vehicle, pedestrian, and the like. The object insertion component 206 may have access to three-dimensional (3D) models for a set of object from which one or more objects may be selected and inserted into the simulation.

To insert objects into a simulation, the object insertion component 206 may analyze the simulated real-world scenario to identify unoccupied portions of the simulated environment at which objects may be inserted. An unoccupied portion of the real-world environment is a portion of the simulated environment in which another object is not currently positioned. The object insertion component 206 may identify the unoccupied portions based on the labels and/or bounding boxes included in the real-world AV scene data that identify the objects and locations/sizes of the objects. The object insertion component 206 may also determine a size/shape of the unoccupied portions as well as a type of the unoccupied portion. For example, the object insertion component 206 may identify the unoccupied portions as being within a street, sidewalk, pedestrian area (e.g., park), and the like.

The object insertion component 206 may insert one or more objects into the identified unoccupied portions. The object insertion component 206 may select an object for insertion at random, based on a user provided selection or prioritization, and/or based on the simulated real-world environment. For example, the object insertion component 206 may select an object that fits a type of simulated real-world environment and/or unoccupied portion of the simulated real-world environment, such as selecting a smaller vehicle (e.g., car) for a residential road, a larger vehicle (e.g., shipping trucks) for a highway or freeway, a pedestrian for a sidewalk or park, and the like. The object insertion component 206 may also select an object based on the size of an unoccupied portion. For example, the object insertion component 206 may select an object that will fit within an unoccupied portion and/or select an unoccupied portion that is large enough for a particular object to be inserted.

The synthetic data point generation component 208 generates synthetic data points based on the objects added to the simulation of the real-world environment. The synthetic data points are similar to the real-world data points in that they describe the location of new objects in the simulation of the real-world environments in relation to the AV. The synthetic data points may similarly be associated with vector data describing the direction of the synthetic data points from the AV (e.g., direction, angle, etc.) in the simulation as well as distance values (e.g., depth values) that indicate the distance of the synthetic data points from the AV. For example, the synthetic data points may simulate LIDAR data generated using LIDAR sensors that cast rays from the AV and detect the depth of objects in the surrounding environment. In some embodiments, the synthetic data points may also include image data, such as pixels that would be captured using an optical sensor (e.g., camera), as well as vector data and distance values captured using different sensors, such as a LIDAR sensor.

The synthetic data point generation component 208 can provide the synthetic data points describing the new objects to the other components of the simulation platform 156, such as the real-world data point identification component 210 and the distance value comparison component 212.

The real-world data point identification component 210 identifies real-world data points from the real-world AV scene data that correspond to the synthetic data points generated by the synthetic data point generation component 208. For example, the real-world data point identification component 210 may use the vector data associated with each synthetic data points to identify corresponding real-world data points that are associated with matching or near-matching vector data. Accordingly, each pair of corresponding real-world and synthetic data points may describe a data point detected from a ray cast at a matching angle/direction from the AV.

The distance value comparison component 212 compares the distance values associated with each corresponding pair of real-world and synthetic data points. For example, the distance value comparison component 212 compares the distance values to determine whether the synthetic data point or the real-world data point is larger. A determination that the distance value associated with the synthetic data point (e.g., synthetic distance value) is equal to or larger than the distance value associated with the real-world data point (e.g., real-world distance value) indicates that an intervening object in the real-world environment would obstruct the AVs perception of the synthetic data point in the real-world environment. Alternatively, a determination that the distance value associated with the synthetic data point (e.g., synthetic distance value) is less than the distance value associated with the real-world data point (e.g., real-world distance value) indicates that there is no intervening object in the real-world environment obstructing the AVs perception of the synthetic data point in the real-world environment.

The distance value comparison component 212 provides data indicating the determination of the comparison performed for each corresponding pair of real-world and synthetic data point to the real-world AV scene data augmentation component 214. The real-world AV scene data augmentation component 214 uses the data provided by the distance value comparison component 212 and the synthetic data points generated by the synthetic data point generation component 208 to augment the real-world AV scene data to add the objects to the real-world scenario. For example, the real-world AV scene data augmentation component 214 replaces a real-world data point in the real-world AV scene data with its corresponding synthetic data point if the real-world distance value is larger than the synthetic distance value. Alternatively, the real-world AV scene data augmentation component 214 maintains a real-world data point in the real-world AV scene data rather than replacing it with its corresponding synthetic data point if the real-world distance value is equal to or less than the synthetic distance value. As a result, synthetic data points describing the added object which would be perceived by the AV are added to the real-world AV scene data, while synthetic data points that would not be perceived by the AV are not added to the real-world AV scene data.

The resulting augmented real-world AV scene data describes a new real-world AV scenario that includes the added object and maintains the highly accurate real-world AV scene data that describes the surrounding environment of the AV. The augmented real-world AV scene data can then be used to train machine learning models used in relation to AVs, such as machine learning models used in a perception stack to identify and label objects.

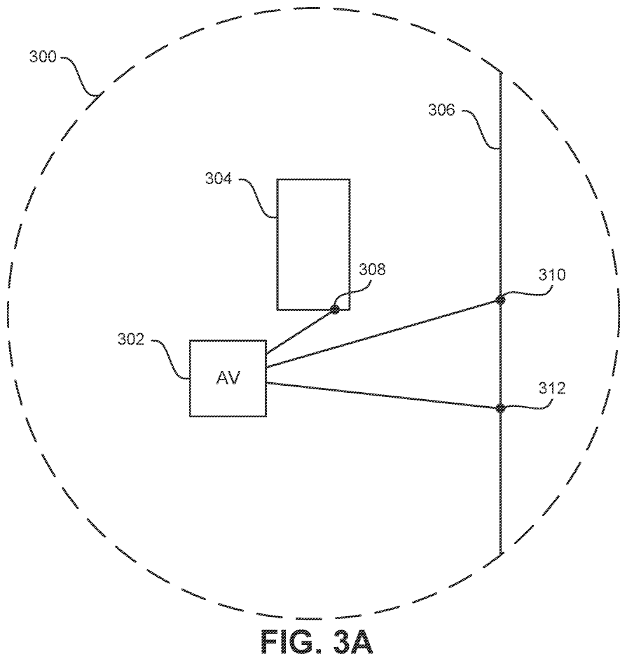

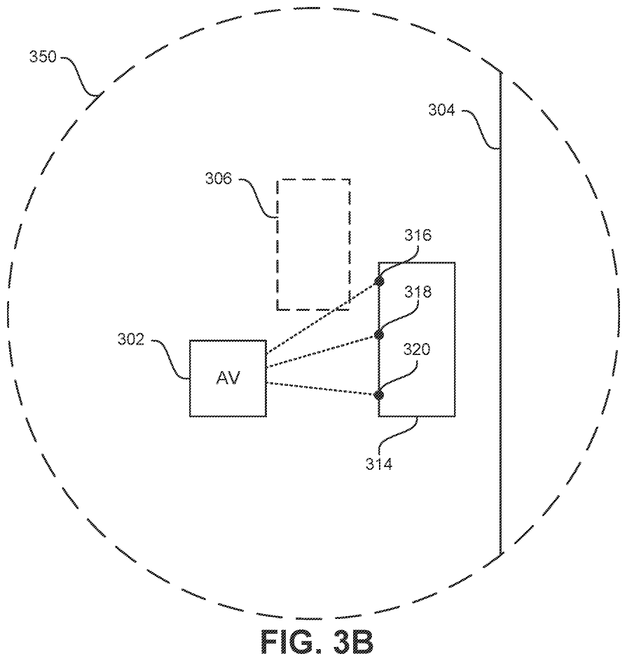

FIGS. 3A-3B illustrate augmenting real-world AV scene data based on synthetic AV scene data, according to some examples of the present disclosure

FIG. 3A illustrates a real-world scenario 300 of an AV 302. As shown, a surrounding object 304 and a background object 306 are present within the real-world scenario 300. FIG. 3B illustrates a simulation of the real-world scenario 350 shown in FIG. 3A including a new object 314. As shown, the surrounding object 304 and the background object 306 are present within the simulation of the real-world scenario 350. To augment real-world AV scene data describing the real-world scenario with synthetic AV scene data describing the new object 314, synthetic data points describing the new object 314 are identified in the simulation of the real-world scenario 350 and corresponding real-world data point are identified in the real-world scenario.

Three example synthetic data points 316, 318, 320 are shown in FIG. 3B, and three corresponding real-world data points 308, 310, 312 are shown in FIG. 3B. Each pair of corresponding synthetic and real-world data points is associated with a same direction and angle from the AV 302. For example, a ray cast from the AV 302 at the same angle and direction would intersect the synthetic data point in the simulation of the real world scenario 350 and the corresponding real-world data point in the real-world scenario 300.

To augment the real-world AV scene data, a real-world distance value associated with a real-world data point is compared to a synthetic distance value associated with the corresponding synthetic data point. If the synthetic distance value is less than the real-world distance value, the real-world AV scene data is augmented to replace the real-world data point with its corresponding synthetic data point. Alternatively, if the synthetic distance value is greater than the real-world distance value, the real-world data point is maintained in the real-world AV scene data. That is, the real-world data point is not replaced with its corresponding synthetic data point in the real-world AV scene data.

As shown, real-world data point 308 correspond to synthetic data point 316. As the distance between the real-world data point 308 and the AV is shorter than the distance between its corresponding the synthetic data point 316, the real-world data point is maintained in the real-world AV scene data. This is because the real-world data point 308 falls on the surrounding object, which obstructs the AVs perception of the new object 314 at the angle and direction associated with the real-world data point 308 and its correspond to synthetic data point 316.

Alternatively, the distance of the other two real-world data points 310, 312 from the AV 302 is greater than the distance of their corresponding synthetic data points 318 to the AV 302. Accordingly, the real-world AV scene data is augmented to replace these real-world data points 310, 312 with their corresponding synthetic data points 318, 320. The resulting augmented real-world AV scene data therefore includes a mix of real-world and synthetic data points that describes the real-world scenario 300 including the new object 314 in such a way that accurately represents the perception of the AV in the newly generated AV scenario.

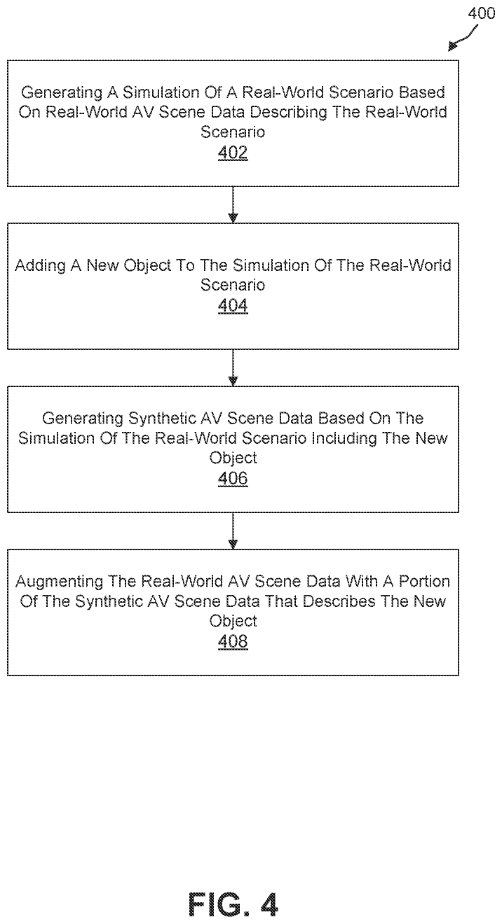

FIG. 4 is a flowchart diagram illustrating an example process for generating augmented real-world AV scene data based on synthetic AV scene data, according to some examples of the present disclosure.

At block 402, the process 400 includes generating a simulation of a real-world scenario based on real-world AV scene data describing the real-world scenario. For example, the simulation generation component 204 may use the real-world AV scene data to generate a simulation of the real-world scenario. This includes placement of the objects detected in the real-world scenario within the simulation to match the positions of the objects relative to the AV in the real-world scenario, as well as configuring the behavior of the AV and the objects within the simulation in a manner that matches their behavior in the real-world scenario. For example, the simulation generation component 204 may configure the speed, trajectory and/or pose of the AV and the surrounding objects within the simulation to match the speed, trajectory and/or pose of the AV and the surrounding objects that occurred in the real-world scenario.

At block 404, the process 400 includes adding a new object to the simulation of the real-world scenario. For example, the object insertion component 206 inserts the new objects into a simulation of a real-world scenario to simulate new real-world scenarios. An object may be any type of object, such as a vehicle, pedestrian, and the like. The object insertion component 206 may have access to three-dimensional (3D) models for a set of object from which one or more objects may be selected and inserted into the simulation.

To insert objects into a simulation, the object insertion component 206 may analyze the simulated real-world scenario to identify unoccupied portions of the simulated environment at which objects may be inserted. An unoccupied portion of the real-world environment is a portion of the simulated environment in which another object is not currently positioned. The object insertion component 206 may identify the unoccupied portions based on the labels and/or bounding boxes included in the real-world AV scene data that identify the objects and locations/sizes of the objects. The object insertion component 206 may also determine a size/shape of the unoccupied portions as well as a type of the unoccupied portion. For example, the object insertion component 206 may identify the unoccupied portions as being within a street, sidewalk, pedestrian area (e.g., park), and the like.

The object insertion component 206 may insert one or more objects into the identified unoccupied portions. The object insertion component 206 may select an object for insertion at random, based on a user provided selection or prioritization, and/or based on the simulated real-world environment. For example, the object insertion component 206 may select an object that fits a type of simulated real-world environment and/or unoccupied portion of the simulated real-world environment, such as selecting a smaller vehicle (e.g., car) for a residential road, a larger vehicle (e.g., shipping trucks) for a highway or freeway, a pedestrian for a sidewalk or park, and the like. The object insertion component 206 may also select an object based on the size of an unoccupied portion. For example, the object insertion component 206 may select an object that will fit within an unoccupied portion and/or select an unoccupied portion that is large enough for a particular object to be inserted.

At block 406, the process 400 includes generating synthetic AV scene data based on the simulation of real-world scenario including the new object. The synthetic data point generation component 208 generates synthetic data points based on the objects added to the simulation of the real-world environment. The synthetic data points are similar to the real-world data points in that they describe the location of new objects in the simulation of the real-world environments in relation to the AV. The synthetic data points may similarly be associated with vector data describing the direction of the synthetic data points from the AV (e.g., direction, angle, etc.) in the simulation as well as distance values (e.g., depth values) that indicate the distance of the synthetic data points from the AV. For example, the synthetic data points may simulate LIDAR data generated using LIDAR sensors that cast rays from the AV and detect the depth of objects in the surrounding environment. In some embodiments, the synthetic data points may also include image data, such as pixels that would be captured using an optical sensor (e.g., camera), as well as vector data and distance values captured using different sensors, such as a LIDAR sensor.

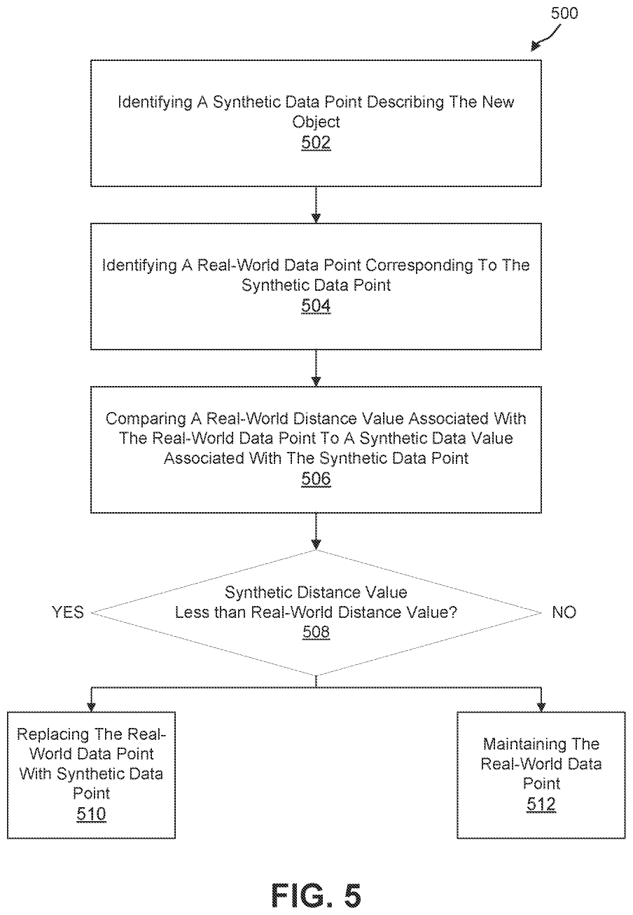

At block 408, the process 400 includes augmenting the real-world AV scene data with a portion of the synthetic AV scene data that describes the new object. For example, the portion of the synthetic AV scene data may include a set of synthetic data points that describe the new object, including vector data describing the direction of the synthetic data points from the AV (e.g., direction, angle, etc.) as well as distance values (e.g., depth values) that indicate the distance of the synthetic data points from the AV. In some embodiments, the simulation platform 156 augments the real-world AV scene data using the process 500 describe in relation to FIG. 5.

FIG. 5 is a flowchart diagram illustrating an example process for augmenting real-world AV scene data based on distance values associated with corresponding real-world and synthetic data points, according to some examples of the present disclosure.

At block 502, the process 500 includes identifying a synthetic data point describing the new object. The synthetic data point may include vector data describing the direction of the synthetic data point from the AV (e.g., direction, angle, etc.) as well as a synthetic distance value (e.g., depth value) that indicate the distance of the synthetic data points from the AV.

At block 504, the process 500 includes identifying a real-world data point corresponding to the synthetic data point. The real-world data point identification component 210 identifies a real-world data point from the real-world AV scene data that corresponds to the synthetic data point generated by the synthetic data point generation component 208. For example, the real-world data point identification component 210 may use the vector data associated with the synthetic data point to identify a corresponding real-world data point that is associated with matching or near-matching vector data. The resulting pair of corresponding real-world and synthetic data points describe a data point detected from a ray cast at a matching angle/direction from the AV.

At block 506, the process 500 includes comparing a real-world distance value associated with the real-world data point to a synthetic data value associated with the synthetic data point. The distance value comparison component 212 compares the distance values associated with the corresponding pair of real-world and synthetic data points to determine whether the synthetic distance value or the real-world data value is larger. A determination that the synthetic distance value is larger than the real-world distance value indicates that an intervening object in the real-world environment would obstruct the AVs perception of the synthetic data point in the real-world environment. Alternatively, a determination that the synthetic distance value is less than the real-world distance value indicates that there is no intervening object in the real-world environment obstructing the AVs perception of the synthetic data point in the real-world environment.

At operation 508, the process includes determining whether the synthetic distance value is less than the real-world distance value. If the synthetic distance value is less than the real-world distance value, at operation 510 the process 500 includes replacing the real-world data point with the synthetic data point in the real-world AV scene data. Alternatively, if the synthetic distance is value is greater than the real-world distance value, at operation 512 the process 500 includes maintaining the real-world data point in the real-world AV scene data. That is, the real-world data point is not replaced by the corresponding synthetic data point.

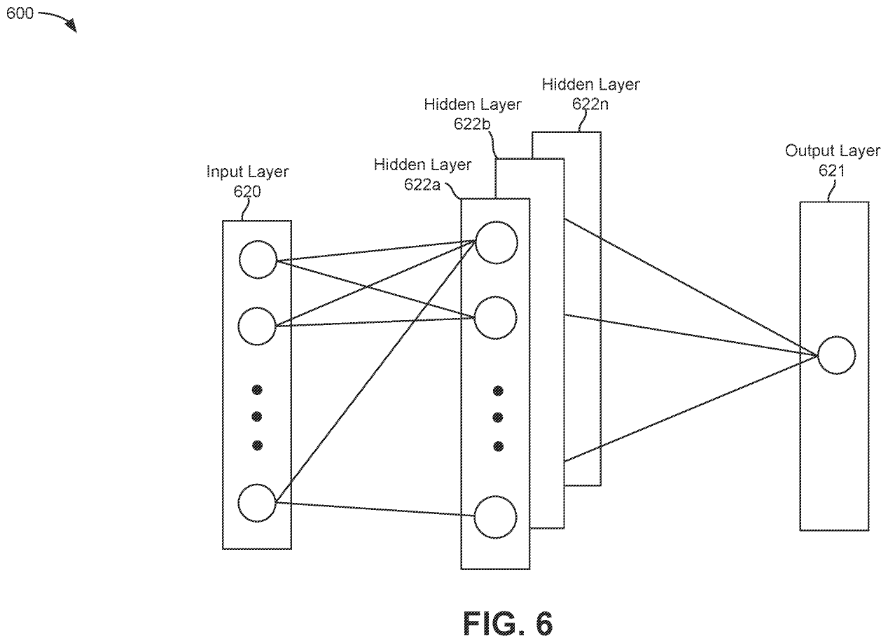

FIG. 6 illustrates an example of a deep learning neural network 600 that can be used in accordance with some examples of the present disclosure. As shown, an input layer 620 can be configured to receive new/modified AV scenarios (e.g., simulation scenario for training machine learning model to handle rare events). The neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. The neural network 600 further includes an output layer 621 that provides an output resulting from the processing performed by the hidden layers 622a, 622b, through 622n. In one illustrative example, the output layer 621 can provide a likelihood value that can represent the probability of a new AV scenario occurring in real-life.

The neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 621.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models: RNNs: CNNs: deep learning: Bayesian symbolic methods: Generative Adversarial Networks (GANs): support vector machines: image registration methods: and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 7 illustrates an example processor-based system with which some aspects of the subject technology can be implemented. For example, processor-based system 700 can be any computing device making up the local computing device 110, a passenger device executing the ridesharing application 172, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some cases, one or more of the described system components represents many such components each performing some or all of the function for which the component is described. In some aspects, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, and/or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 can include an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple R: Lightning R port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACONR wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 740) may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory StickR card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 730 can include software services, servers, services, etc., that when the code that defines such software is executed by the processor 710, causes the system to perform a function. In some examples, a hardware service that performs a particular function can include the software component stored in a computer-readable medium in connection with the necessary hardware components, such as processor 710, connection 705, output device 735, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks: convolutional neural networks (CNNs): deep learning; Bayesian symbolic methods: general adversarial networks (GANs): support vector machines: image registration methods: applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

### Selected Examples

### Illustrative Examples of the Disclosure Include:

Aspect 1. A computer-implemented method comprising: generating, based on real-world autonomous vehicle (AV) scene data captured by sensors of an AV during a real-world scenario, a simulation of the real-world scenario: adding a first object to the simulation of the real-world scenario: generating synthetic AV scene data based on the simulation of the real-world scenario including the first object: and augmenting the real-world AV scene data with a portion of the synthetic AV scene data that describes the first object, resulting in augmented real-world AV scene data that describes real-world scenario including the first object.

Aspect 2. The computer-implemented method of Aspect 1, further comprising: training a machine learning model based on the augmented real-world AV scene data.

Aspect 3. The computer-implemented method of any of Aspects 1 to 2, wherein augmenting the real-world AV scene data with the portion of the synthetic AV scene data that describes the first object comprises: identifying a first synthetic data point in the portion of the synthetic AV scene data, the first synthetic data point being associated with a first synthetic distance value indicating a distance of the first synthetic data point from a position of the AV within the simulation of the real-world scenario: identifying a first real-world data point in the real-world AV scene data that corresponds to the first synthetic data point, the first real-world data point being associated with a first real-world distance value indicating a distance of the first real-world data point from a position of the AV within the real-world scenario: and modifying the real-world AV scene data based on a comparison of the first synthetic distance value to the first real-world distance value.

Aspect 4. The computer-implemented method of any of Aspects 1 to 3, wherein modifying the real-world AV scene data based on the comparison of the first synthetic distance value to the first real-world distance value comprises: replacing the first real-world data point with the first synthetic data point based on determining that the first synthetic distance value is less than the first real-world distance value.

Aspect 5. The computer-implemented method of any of Aspects 1 to 4, wherein modifying the real-world AV scene data based on the comparison of the first synthetic distance value to the first real-world distance value comprises: maintaining the first real-world data point based on determining that the first synthetic distance value is less than the first real-world distance value.

Aspect 6. The computer-implemented method of any of Aspects 1 to 5, wherein augmenting the real-world AV scene data with the portion of the synthetic AV scene data that describes the first object further comprises: identifying a second synthetic data point in the portion of the synthetic AV scene data, the second synthetic data point being associated with a second synthetic distance value indicating a distance of the second synthetic data point from the position of the AV within the simulation of the real-world scenario: identifying a second real-world data point in the real-world AV scene data that corresponds to the second synthetic data point, the second real-world data point being associated with a second real-world distance value indicating a distance of the second real-world data point from the position of the AV within the real-world scenario: and modifying the real-world AV scene data based on a comparison of the second synthetic distance value to the second real-world distance value.

Aspect 7. The computer-implemented method of any of Aspects 1 to 6, further comprising: adding a second object to the simulation of the real-world scenario; and augmenting the real-world AV scene data with a portion of the synthetic AV scene data that describes the second object.

Aspect 8. A system comprising: one or more computer processors: and one or more computer-readable mediums storing instructions that, when executed by the one or more computer processors, cause the system to perform operations comprising:

generating, based on real-world autonomous vehicle (AV) scene data captured by sensors of an AV during a real-world scenario, a simulation of the real-world scenario: adding a first object to the simulation of the real-world scenario: generating synthetic AV scene data based on the simulation of the real-world scenario including the first object: and augmenting the real-world AV scene data with a portion of the synthetic AV scene data that describes the first object, resulting in augmented real-world AV scene data that describes real-world scenario including the first object.

Aspect 9. The system of Aspects 8, the operations further comprising: training a machine learning model based on the augmented real-world AV scene data.

Aspect 10. The system of any of Aspects 8-9, wherein augmenting the real-world AV scene data with the portion of the synthetic AV scene data that describes the first object comprises: identifying a first synthetic data point in the portion of the synthetic AV scene data, the first synthetic data point being associated with a first synthetic distance value indicating a distance of the first synthetic data point from a position of the AV within the simulation of the real-world scenario: identifying a first real-world data point in the real-world AV scene data that corresponds to the first synthetic data point, the first real-world data point being associated with a first real-world distance value indicating a distance of the first real-world data point from a position of the AV within the real-world scenario: and modifying the real-world AV scene data based on a comparison of the first synthetic distance value to the first real-world distance value.

Aspect 11. The system of any of Aspects 8-10, wherein modifying the real-world AV scene data based on the comparison of the first synthetic distance value to the first real-world distance value comprises: replacing the first real-world data point with the first synthetic data point based on determining that the first synthetic distance value is less than the first real-world distance value.

Aspect 12. The system of any of Aspects 8-11, wherein modifying the real-world AV scene data based on the comparison of the first synthetic distance value to the first real-world distance value comprises: maintaining the first real-world data point based on determining that the first synthetic distance value is less than the first real-world distance value.

Aspect 13. The system of any of Aspects 8-12, wherein augmenting the real-world AV scene data with the portion of the synthetic AV scene data that describes the first object further comprises: identifying a second synthetic data point in the portion of the synthetic AV scene data, the second synthetic data point being associated with a second synthetic distance value indicating a distance of the second synthetic data point from the position of the AV within the simulation of the real-world scenario: identifying a second real-world data point in the real-world AV scene data that corresponds to the second synthetic data point, the second real-world data point being associated with a second real-world distance value indicating a distance of the second real-world data point from the position of the AV within the real-world scenario: and modifying the real-world AV scene data based on a comparison of the second synthetic distance value to the second real-world distance value.

Aspect 14. The system of any of Aspects 8-13, the operations further comprising: adding a second object to the simulation of the real-world scenario: and augmenting the real-world AV scene data with a portion of the synthetic AV scene data that describes the second object.

Aspect 15. A non-transitory computer-readable medium storing instructions that, when executed by one or more computer processors of one or more computing devices, cause the one or more computing devices to perform operations comprising: generating, based on real-world autonomous vehicle (AV) scene data captured by sensors of an AV during a real-world scenario, a simulation of the real-world scenario: adding a first object to the simulation of the real-world scenario: generating synthetic AV scene data based on the simulation of the real-world scenario including the first object: and augmenting the real-world AV scene data with a portion of the synthetic AV scene data that describes the first object, resulting in augmented real-world AV scene data that describes real-world scenario including the first object.

Aspect 16. The non-transitory computer-readable medium of Aspect 15, the operations further comprising: training a machine learning model based on the augmented real-world AV scene data.

Aspect 17. The non-transitory computer-readable medium of any of Aspects 15-16, wherein augmenting the real-world AV scene data with the portion of the synthetic AV scene data that describes the first object comprises: identifying a first synthetic data point in the portion of the synthetic AV scene data, the first synthetic data point being associated with a first synthetic distance value indicating a distance of the first synthetic data point from a position of the AV within the simulation of the real-world scenario; identifying a first real-world data point in the real-world AV scene data that corresponds to the first synthetic data point, the first real-world data point being associated with a first real-world distance value indicating a distance of the first real-world data point from a position of the AV within the real-world scenario: and modifying the real-world AV scene data based on a comparison of the first synthetic distance value to the first real-world distance value.

Aspect 18. The non-transitory computer-readable medium of any of Aspects 15-17, wherein modifying the real-world AV scene data based on the comparison of the first synthetic distance value to the first real-world distance value comprises: replacing the first real-world data point with the first synthetic data point based on determining that the first synthetic distance value is less than the first real-world distance value.

Aspect 19. The non-transitory computer-readable medium of any of Aspects 15-18, wherein modifying the real-world AV scene data based on the comparison of the first synthetic distance value to the first real-world distance value comprises: maintaining the first real-world data point based on determining that the first synthetic distance value is less than the first real-world distance value.

Aspect 20. The non-transitory computer-readable medium of any of Aspects 15-19, wherein augmenting the real-world AV scene data with the portion of the synthetic AV scene data that describes the first object further comprises: identifying a second synthetic data point in the portion of the synthetic AV scene data, the second synthetic data point being associated with a second synthetic distance value indicating a distance of the second synthetic data point from the position of the AV within the simulation of the real-world scenario: identifying a second real-world data point in the real-world AV scene data that corresponds to the second synthetic data point, the second real-world data point being associated with a second real-world distance value indicating a distance of the second real-world data point from the position of the AV within the real-world scenario: and modifying the real-world AV scene data based on a comparison of the second synthetic distance value to the second real-world distance value.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
generating, based on real-world autonomous vehicle (AV) scene data captured by sensors of an AV during a real-world scenario, a simulation of the real-world scenario:
adding a first object to the simulation of the real-world scenario;
generating synthetic AV scene data based on the simulation of the real-world scenario, including the first object; and
augmenting the real-world AV scene data with a portion of the synthetic AV scene data that describes the first object, resulting in augmented real-world AV scene data that describes real-world scenario, including the first object.

2. The computer-implemented method of claim 1, further comprising:
training a machine learning model based on the augmented real-world AV scene data.

3. The computer-implemented method of claim 1, wherein augmenting the real-world AV scene data with the portion of the synthetic AV scene data that describes the first object comprises:
identifying a first synthetic data point in the portion of the synthetic AV scene data, the first synthetic data point being associated with a first synthetic distance value indicating a distance of the first synthetic data point from a position of the AV within the simulation of the real-world scenario:
identifying a first real-world data point in the real-world AV scene data that corresponds to the first synthetic data point, the first real-world data point being associated with a first real-world distance value indicating a distance of the first real-world data point from a position of the AV within the real-world scenario; and
modifying the real-world AV scene data based on a comparison of the first synthetic distance value to the first real-world distance value.

4. The computer-implemented method of claim 3, wherein modifying the real-world AV scene data based on the comparison of the first synthetic distance value to the first real-world distance value comprises:
replacing the first real-world data point with the first synthetic data point based on determining that the first synthetic distance value is less than the first real-world distance value.

5. The computer-implemented method of claim 3, wherein modifying the real-world AV scene data based on the comparison of the first synthetic distance value to the first real-world distance value comprises:
maintaining the first real-world data point based on determining that the first synthetic distance value is less than the first real-world distance value.

6. The computer-implemented method of claim 3, wherein augmenting the real-world AV scene data with the portion of the synthetic AV scene data that describes the first object further comprises:
identifying a second synthetic data point in the portion of the synthetic AV scene data, the second synthetic data point being associated with a second synthetic distance value indicating a distance of the second synthetic data point from the position of the AV within the simulation of the real-world scenario;
identifying a second real-world data point in the real-world AV scene data that corresponds to the second synthetic data point, the second real-world data point being associated with a second real-world distance value indicating a distance of the second real-world data point from the position of the AV within the real-world scenario; and
modifying the real-world AV scene data based on a comparison of the second synthetic distance value to the second real-world distance value.

7. The computer-implemented method of claim 1, further comprising:
adding a second object to the simulation of the real-world scenario; and
augmenting the real-world AV scene data with a portion of the synthetic AV scene data that describes the second object.

8. A system comprising:
one or more computer processors; and
one or more computer-readable mediums storing instructions that, when executed by the one or more computer processors, cause the system to perform operations comprising:
generating, based on real-world autonomous vehicle (AV) scene data captured by sensors of an AV during a real-world scenario, a simulation of the real-world scenario:
adding a first object to the simulation of the real-world scenario:
generating synthetic AV scene data based on the simulation of the real-world scenario including the first object; and
augmenting the real-world AV scene data with a portion of the synthetic AV scene data that describes the first object, resulting in augmented real-world AV scene data that describes real-world scenario including the first object.

9. The system of claim 8, the operations further comprising:
training a machine learning model based on the augmented real-world AV scene data.

10. The system of claim 8, wherein augmenting the real-world AV scene data with the portion of the synthetic AV scene data that describes the first object comprises:
identifying a first synthetic data point in the portion of the synthetic AV scene data, the first synthetic data point being associated with a first synthetic distance value indicating a distance of the first synthetic data point from a position of the AV within the simulation of the real-world scenario:
identifying a first real-world data point in the real-world AV scene data that corresponds to the first synthetic data point, the first real-world data point being associated with a first real-world distance value indicating a distance of the first real-world data point from a position of the AV within the real-world scenario; and
modifying the real-world AV scene data based on a comparison of the first synthetic distance value to the first real-world distance value.

11. The system of claim 10, wherein modifying the real-world AV scene data based on the comparison of the first synthetic distance value to the first real-world distance value comprises:
replacing the first real-world data point with the first synthetic data point based on determining that the first synthetic distance value is less than the first real-world distance value.

12. The system of claim 10, wherein modifying the real-world AV scene data based on the comparison of the first synthetic distance value to the first real-world distance value comprises:
maintaining the first real-world data point based on determining that the first synthetic distance value is less than the first real-world distance value.

13. The system of claim 10, wherein augmenting the real-world AV scene data with the portion of the synthetic AV scene data that describes the first object further comprises:
identifying a second synthetic data point in the portion of the synthetic AV scene data, the second synthetic data point being associated with a second synthetic distance value indicating a distance of the second synthetic data point from the position of the AV within the simulation of the real-world scenario;
identifying a second real-world data point in the real-world AV scene data that corresponds to the second synthetic data point, the second real-world data point being associated with a second real-world distance value indicating a distance of the second real-world data point from the position of the AV within the real-world scenario; and
modifying the real-world AV scene data based on a comparison of the second synthetic distance value to the second real-world distance value.

14. The system of claim 8, the operations further comprising:
adding a second object to the simulation of the real-world scenario; and
augmenting the real-world AV scene data with a portion of the synthetic AV scene data that describes the second object.

15. A non-transitory computer-readable medium storing instructions that, when executed by one or more computer processors of one or more computing devices, cause the one or more computing devices to perform operations comprising:
generating, based on real-world autonomous vehicle (AV) scene data captured by sensors of an AV during a real-world scenario, a simulation of the real-world scenario;
adding a first object to the simulation of the real-world scenario:
generating synthetic AV scene data based on the simulation of the real-world scenario including the first object; and
augmenting the real-world AV scene data with a portion of the synthetic AV scene data that describes the first object, resulting in augmented real-world AV scene data that describes real-world scenario including the first object.

16. The non-transitory computer-readable medium of claim 15, the operations further comprising:
training a machine learning model based on the augmented real-world AV scene data.

17. The non-transitory computer-readable medium of claim 15, wherein augmenting the real-world AV scene data with the portion of the synthetic AV scene data that describes the first object comprises:
identifying a first synthetic data point in the portion of the synthetic AV scene data, the first synthetic data point being associated with a first synthetic distance value indicating a distance of the first synthetic data point from a position of the AV within the simulation of the real-world scenario:
identifying a first real-world data point in the real-world AV scene data that corresponds to the first synthetic data point, the first real-world data point being associated with a first real-world distance value indicating a distance of the first real-world data point from a position of the AV within the real-world scenario; and
modifying the real-world AV scene data based on a comparison of the first synthetic distance value to the first real-world distance value.

18. The non-transitory computer-readable medium of claim 17, wherein modifying the real-world AV scene data based on the comparison of the first synthetic distance value to the first real-world distance value comprises:
replacing the first real-world data point with the first synthetic data point based on determining that the first synthetic distance value is less than the first real-world distance value.

19. The non-transitory computer-readable medium of claim 17, wherein modifying the real-world AV scene data based on the comparison of the first synthetic distance value to the first real-world distance value comprises:
maintaining the first real-world data point based on determining that the first synthetic distance value is less than the first real-world distance value.

20. The non-transitory computer-readable medium of claim 17, wherein augmenting the real-world AV scene data with the portion of the synthetic AV scene data that describes the first object further comprises:
identifying a second synthetic data point in the portion of the synthetic AV scene data, the second synthetic data point being associated with a second synthetic distance value indicating a distance of the second synthetic data point from the position of the AV within the simulation of the real-world scenario;
identifying a second real-world data point in the real-world AV scene data that corresponds to the second synthetic data point, the second real-world data point being associated with a second real-world distance value indicating a distance of the second real-world data point from the position of the AV within the real-world scenario; and
modifying the real-world AV scene data based on a comparison of the second synthetic distance value to the second real-world distance value.
